(19) United States
(12) Patent Application Publication
(10) Pub. No.: US 2019/0334778 A1
(43) Pub. Date: Oct. 31, 2019

(54) GENERIC ACCESS TO HETEROGENEOUS VIRTUALIZED ENTITIES

(71) Applicant: Nutanix, Inc., San Jose, CA (US)

(72) Inventors: Ranjan PARTHASARATHY, Milpitas, CA (US); Akshay Anant DEODHAR, Cupertino, CA (US)

(73) Assignee: Nutanix, Inc., San Jose, CA (US)

(21) Appl. No.: 15/826,658

(22) Filed: Nov. 29, 2017

Related U.S. Application Data
(60) Provisional application No. 62/428,408, filed on Nov. 30, 2016.

(51) Int. Cl. H04L 12/24; G06F 9/455

(52) U.S. Cl. CPC H04L 41/12; G06F 2009/45579; G06F 9/45558

(57) ABSTRACT

Systems and methods for providing generic access web service entry points for virtualized entities in a computing system. A method embodiment commences by identifying a code base comprising one or more arbitrarily-named entity management functions. A set of generically-named entry points are defined and exposed. A data structure that comprises mappings between generically-named entry points and respective arbitrarily-named entity management functions is defined. When a call to one of the generically-named entry points is received, characteristics of the call itself and/or the call parameters are examined. The data structure comprising the mappings is accessed to determine a corresponding set of one or more arbitrarily-named entity management functions. The corresponding set of arbitrarily-named entity management functions is executed on behalf of the caller. Results are returned to the caller in a format as specified by the call parameters, or as formatted by the entity management function, or in a default format.

### RELATED APPLICATIONS

The present application claims the benefit of priority to co-pending U.S. Provisional Patent Application Ser. No. 62/428,408 titled, “GENERIC ACCESS TO SEMANTICALLY IDENTICAL VIRTUALIZED ENTITY ATTRIBUTES”, filed Nov. 30, 2016, which is hereby incorporated by reference in its entirety

### FIELD

This disclosure relates to virtualized computing systems, and more particularly to techniques for generic access to heterogeneous virtualized entities within such virtualized computing systems.

### BACKGROUND

Many modern computing systems employ virtualized entities (VEs), such as virtual machines (VMs), to improve the utilization of computing resources. Such VMs can be characterized as software-based computing “machines” implemented in a hypervisor-assisted or other virtualization environment that emulates the underlying hardware resources (e.g., CPU, memory, etc.). For example, multiple VMs can operate on one physical machine (e.g., host computer) running a single host operating system, while the VMs run multiple applications on various respective guest operating systems

The use of VMs and other VEs in computing systems to improve the utilization of computing resources continues to increase. There are numerous types of virtualization systems that are currently available to be employed by users. Each of these virtualization systems may have their own unique and/or specific approaches to implementing VEs and the infrastructure to manage/support the VEs. In fact, it is possible that a single installation may include VEs and their underlying infrastructure from multiple different vendors. Accordingly, in a heterogeneous environment, many VEs might be developed by and/or deployed by multiple vendors.

Unfortunately, managing such dynamic, separately-developed heterogeneous virtualized entities can present challenges. Specifically, multiple developers of a certain types of VEs (e.g., VMs) might define different identifiers for semantically equivalent VE attributes. For example, one developer might use “vmID” to uniquely identify a VM, while another developer might use “vmName” to uniquely identify a VM. Also, multiple developers of a VE might define different handles for certain semantically-equivalent VE management functions. For example, one developer might invoke a VM using a “vm_start” function call, while another developer might invoke a VM using a “vm_launch” function call.

As time progresses, developers introduce more and more syntactically disparate or semantically disparate methods (e.g., application programming interfaces or APIs) corresponding to newly-introduced VEs and/or newly-introduced VE infrastructure/management methods or functions. Such techniques place a significant burden on the developers, users and system administrators of the distributed system provider to maintain a knowledge of the varying access methods for the many VEs in a particular distributed system. What is needed is a technological solution for reducing the burdens placed on developers, users and system administrators.

### SUMMARY

The present disclosure provides a detailed description of techniques used in systems, methods, and in computer program products for providing generic access to heterogeneous virtualized entities, which techniques advance the relevant technologies to address technological issues with legacy approaches. More specifically, the present disclosure provides a detailed description of techniques used in systems, methods, and in computer program products for managing heterogeneous virtualized entities using a generic interface. Certain embodiments are directed to technological solutions for mapping generically-structured entity management calls to entity-specific management functions that are executed in accordance with access control constraints.

The disclosed embodiments modify and improve over legacy approaches. In particular, the herein-disclosed techniques provide technical solutions that address the technical problems attendant to efficiently managing a dynamically-changing corpus of heterogeneous virtualized entities. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of computing cluster management, where functionality that formerly resided in hard-to-manage code is replaced by a framework comprising easier-to-manage data. The disclosed techniques provide advances in various technical fields related to deployment of ‘open’ virtualized computing systems where developers can introduce new virtualized entities into the system, which new entities can be managed by an administrator.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 illustrates a computing environment in which embodiments of the present disclosure can be implemented.

FIG. 2 depicts an entity management technique as implemented in systems that facilitate managing heterogeneous virtualized entities using a generic interface, according to an embodiment.

FIG. 3 presents an entity management framework setup technique used in systems that facilitate managing heterogeneous virtualized entities using a generic interface, according to an embodiment.

FIG. 4 depicts an entity management function execution technique as implemented in systems that facilitate managing heterogeneous virtualized entities using a generic interface, according to an embodiment.

FIG. 5 depicts diagrammatic representations of entity management functions used by systems that facilitate managing heterogeneous virtualized entities using a generic interface, according to an embodiment.

FIG. 6 presents an attribute transformer implementation technique that facilitates managing heterogeneous virtualized entities using a generic interface, according to an embodiment.

FIG. 7 depicts a distributed virtualization environment in which embodiments of the present disclosure can be implemented.

FIG. 8 depicts system components as arrangements of computing modules that are interconnected so as to implement certain of the herein-disclosed embodiments.

FIG. 9A, FIG. 9B and FIG. 9C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of efficiently managing a dynamically-changing corpus of heterogeneous virtualized entities. Some embodiments are directed to approaches for mapping generically-structured entity management calls to entity-specific management functions that are executed in accordance with access control constraints. The accompanying figures and discussions herein present example environments, systems, methods, and computer program products for managing heterogeneous virtualized entities using a generic interface.

### Overview

Disclosed herein are techniques for mapping generically-structured entity management calls to entity-specific management functions that are executed in accordance with access control constraints. In certain embodiments, a code base comprising sets of entity management functions (e.g., list, create, delete, etc.) for various virtualized computing entities is established. A data structure to facilitate access to the entity management functions from a generic interface (e.g., /list, /create, /delete, etc.) is also implemented. Responsive to some generation event (e.g., administrative action, entity management function change, system boot event, etc.), executable versions of the entity management functions (e.g., list, create, delete, etc.) are generated and exposed via entry points to the generic interface (e.g., /list, /create, /delete, etc.). When a generic call is received at the generic interface, one or more call parameters are applied to the data structure to map the generically-structured call to a corresponding entity management function. The identified entity management function is then executed. In certain embodiments, the entity management function comprises access control constraints.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

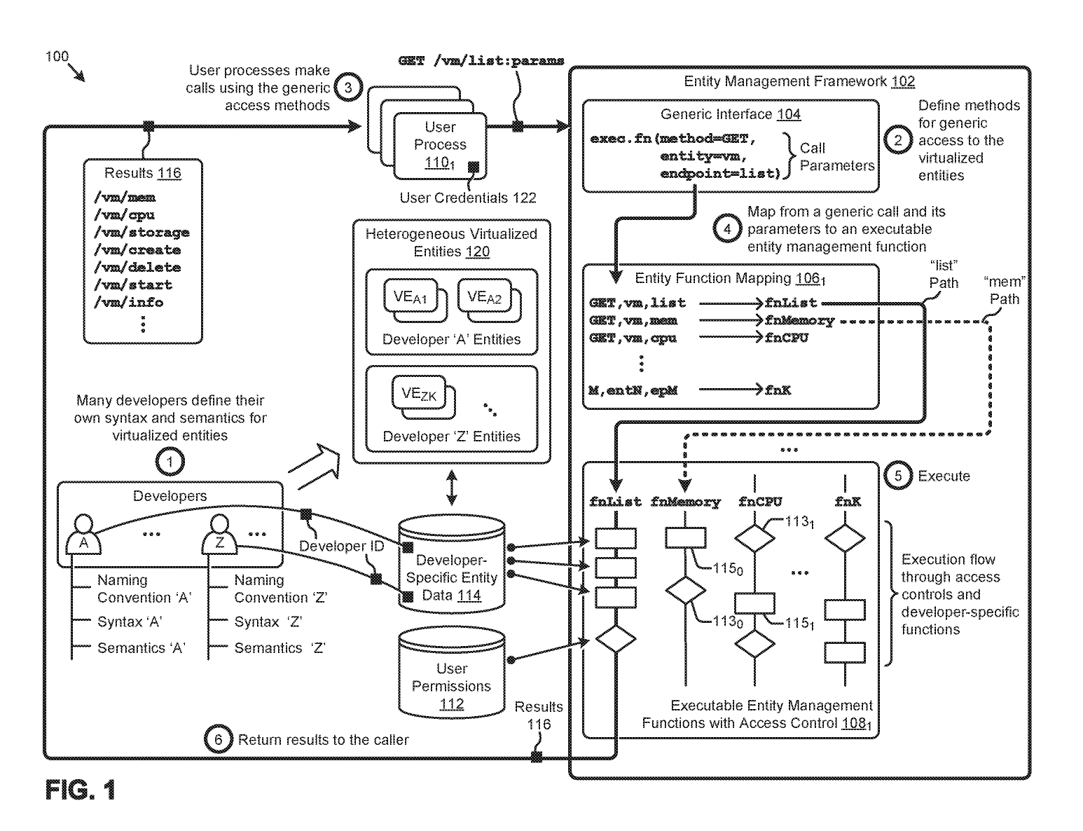

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

As shown, at operation 1, many different developers (e.g., different vendors) define virtualized entities (e.g., virtual machines). The specific naming conventions and/or syntax, and/or semantics that are used by one developer (e.g., developer ‘A’) is likely to be different from the specific naming conventions and/or syntax, and/or semantics used by another developer (e.g., developer ‘Z’). This sets up a potential explosion of code that authors of user processes would need to develop and maintain in order to manage virtualized entities that come from different vendors. This scenario becomes more and more acute as more and more developers deliver more and more entities.

The aforementioned code explosion can be ameliorated by providing a generic interface to users. In this example, and at operation 2, a generic interface is architected, and a set of generic methods for accessing specific entities of specific entity types from specific developers is defined. The generic interface includes a generic call to a “list” function that returns a list of generic calls that are supported for a particular entity type. As such, at operation 3, a user process can make a call to the generic interface. In this example, the call to the generic interface is shown as “GET/vm/list”. The action of the call is to provide results of the generic interface call back to the caller in the form of a “list” or set of generic functions that are supported for the specified entity type (e.g., entity type of “vm”). After receiving the “list” or set of generic functions that are supported for the specified entity type, the user process can make calls to the full range of supported generic functions for that entity type.

For example, and continuing the shown depiction of FIG. 1, after a user process performs a generic call using the “GET/vm/list” construction that traverses through the “list” path to the executable function “fnList”, the same user process might make a supported generic call to retrieve memory-related information about a particular VM by using the construction “GET /vm/mem”. In this case, after performing entity function mapping, the “mem” path is taken and the function “fnMemory” is executed.

The user process might continue to make any one or more of the supported generic calls that were returned in the results 116 to manipulate a particular entity. Any of the supported generic calls can be accessed by using the generic call construction “/[entity]/[endpoint:params]”, where [entity] is an entity identifier and where [params] is a set of passed-in parameters that correspond to the entity and generic call.

A correspondence between a generic call and a respective specific executable function is achieved by the shown entity function mapping 106₁ (operation 4). Specifically, and as shown in this example, the combination of the generic call, its parameters, and any other information that can be derived from and/or inferred from the generic call and/or its parameters is used to map to an entity management function. In this example, the “GET/vm/list” construction maps to the executable function “fnList”, and the “GET/vm/mem” construction maps to the executable function “fnMemory”, and so on. The mapped-to entity management function is executed at operation 5, and in the course of execution of the mapped-to entity management function, any one or more developer-specific functions (e.g., developer-specific function 115o) might be executed, and any one or more access controls (e.g., access control decision 113o) might be checked and enforced. At operation 6, results from the execution of the mapped-to entity management function are returned to the caller.

Continuing the explanation of this example, the depiction of FIG. 1 includes additional specific entity management functions, namely “fnCPU”, and “fnK”. Each of these entity management functions have a corresponding mapped-to flow that might include a combination of developer-specific functions calls (e.g., developer-specific function 115₁) and applicable access control decisions (e.g., access control decision 113₁). In this manner, users can access and/or control developer-specific entities without having to know and/or code in the names and/or syntax of developer-specific functions. Rather, using the described mapping, a user call to a generic interface can be mapped to a developer-specific function on behalf of the caller, then executed as if the user had known and written code to refer to the developer-specific names and/or syntax.

Further details pertaining to techniques for mapping are described in the paragraphs below, as well as being shown and described as pertains to the appended figures. The mapping techniques can be used in any computing environment.

The embodiment shown in FIG. 1 is merely one example of a computing environment in which the herein disclosed techniques can be implemented. As shown, the computing environment 100 comprises a plurality of virtualized entities, depicted as the example set of heterogeneous virtualized entities 120. The example set of heterogeneous virtualized entities are heterogeneous at least because the set comprises sets of separately-developed virtualized entities (VEs), any of which VEs use their own corresponding developer-specific naming conventions and syntax. As representative examples, “Developer ‘A’ Entities” comprise multiple instances of VEs from a first developer. Specifically, a first developer ‘A’ entity of a first type is shown as VE_{A1}, and a second developer ‘A’ entity of a second type is shown as VE_{A2}. Also depicted in the shown “Developer ‘Z’ Entities”, which are instances of a virtualized entity VE_{ZK} that represents a Kth VE type from developer “Z”.

As earlier mentioned, efficiently managing such heterogeneous VEs can present challenges. More particularly, one way to implement solutions to the problems that arise from having multiple developers that have corresponding virtualized entities is to define and support an entity management framework 102 for mapping between generic calls and the corresponding underlying developer-specific calls. In some computing systems, a generic call interface is implemented by using web services that are accessed using the “http:” protocol to specify a web service entry point.

Specifically, entity management framework 102 comprises a generic interface 104 to receive requests (e.g., HTTP requests) from various user processes (e.g., user process 110₁). The user processes, for example, are processes invoked by a particular user (e.g., individual, user group, tenant group, enterprise, resource owner, etc.) to perform certain entity management operations. The generic interface 104 facilitates issuance of such requests in a generically-structured format.

Continuing again with the example of FIG. 1, when one of the user processes executes the generic call “list”, it provides a set of call parameters. Specifically, and as shown, one possible syntax for making a generic call uses the form “[method]/[entity]/[endpoint:parameters]” where, in this case, the “[method]” is http “GET”, the “[entity]” is “vm”, and the “[endpoint:parameters]” portion of the call interface is just “list”, thus indicating a case where the parameters are null. The results of such a generic call to “list” returns results in the form of a set of additional calls that can be made over the entity type “vm”. As shown, the results 116 are given as a set of endpoints, each of which corresponds to a generic interface that can be used to get or set information pertaining to memory (e.g., using the “mem” endpoint), and/or to the underlying central processing unit (e.g., using the “cpu” endpoint), and/or to storage (e.g., using the “storage” endpoint), etc. The generic interface call invokes a web service, which in turn invokes a function handler that in turn processes developer-specific functions pertaining to the specific entity.

Continuing the discussion of FIG. 1, as an example to explain the operation of a function handler, a request from user process 110₁ that is issued in the form “[method]/[entity]/[endpoint]” is received by an “exec.fn( )” handler at generic interface 104. A set of user credentials 122 (e.g., in a user session cookie) associated with the requester is also received at generic interface 104. The call parameters (e.g., “method=GET”, “entity=vm”, “endpoint=list”) received at generic interface 104 are mapped to a specific entity management function (e.g., “fnList”) using an entity function mapping 106₁ at the entity management framework 102.

The entity management function (e.g., “fnList”) identified by the entity function mapping 106₁ is one of many functions (e.g., “fnMemory”, “fnCPU”, . . . , “fnK”) comprising a set of executable entity management functions with access control 1081. This set of functions are often executable entity management functions accessible by the entity management framework 102 to perform an operation (e.g., transform) or pipeline of operations (e.g., transformer) over one or more VEs. Various data in computing environment 100 can be accessed to perform such operations.

For example, and as shown, the entity management functions might access a set of user permissions 112 to facilitate application of access control constraints on certain entity management operations. Specifically, user credentials 122 associated with user process 110₁ can be used to determine which user permissions 112 apply to which particular entity management operations. In turn, the determination is used to allow or deny the requested operation(s). A set of developer-specific entity data 114 characterizing heterogeneous virtualized entities 120 might be accessed to carry out the entity management operations of the executable entity management functions with access control 1081. As one specific case, and as shown, a developer ID is included in the developer-specific entity data 114. As such, an access to the developer-specific entity data for a particular entity can look up the developer that corresponds to the given entity. In some cases, a particular entity is identified by a universal ID (UID) that uniquely identifies the particular entity. Given the unique identification, any characteristics of that particular entity can be determined from system-accessible data such as, but not limited to, developer-specific entity data 114.

Executing the identified entity management function will often return a set of results to the issuing user process. Specifically, and as shown in the example, issuing a “GET vm/list” call returns a set of results 116 comprising a “list” of callable handles (e.g., web service or microservice endpoints) associated with a “vm” entity. As can be observed, these endpoints are structured so as to be received at generic interface 104 for processing by the entity management framework.

As heretofore discussed, the action of establishing a generic call interface with a relatively small set of entity management call semantics in combination with a computer-implemented facility to map from individual ones of the relatively small set of calls to a much large set of developer-specific entity management functions means that user processes can be coded to manipulate virtualized entities using the relatively small set of entity management call semantics rather than having to code in accordance with the developer-specific names, syntax and semantics. Therefore, the degree of code maintenance of user processes is greatly reduced. In many cases, a developer can release new developer-specific entity management functions that can be used immediately by user processes without needing to modify the user process code.

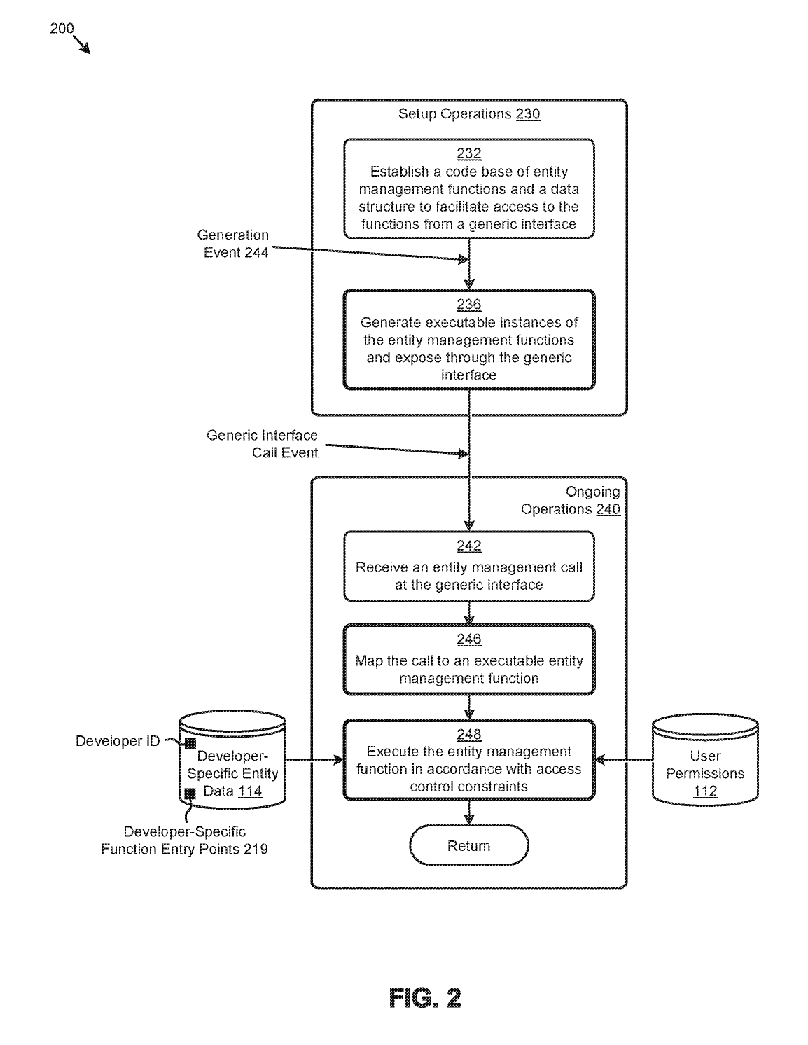

Further details describing certain setup operations and ongoing operations facilitated by the techniques disclosed herein are shown and discussed as pertaining to FIG. 2.

FIG. 2 depicts an entity management technique 200 as implemented in systems that facilitate managing heterogeneous virtualized entities using a generic interface. As an option, one or more variations of entity management technique 200 or any aspect thereof may be implemented in the context of the architecture and functionality of the embodiments described herein. The entity management technique 200 or any aspect thereof may be implemented in any environment.

The entity management technique 200 presents one embodiment of certain steps and/or operations that facilitate managing heterogeneous virtualized entities using a generic interface. As illustrated, the entity management technique 200 can comprise a set of setup operations 230 and a set of ongoing operations 240. Specifically, the setup operations might commence by establishing a code base of entity management functions, and a data structure to facilitate access to the entity management functions by a generic interface (step 232). A code base is a collection of source code that is used to build one or more software components, such as an operating system, an application, a function, a script, and/or other components. The source code in a code base is often created by a human (e.g., developer), but might also be generated by various development tools. Portions of the code base can be used to build executable instances (e.g., executables) of the corresponding software component. Other portions (e.g., property files, etc.) can be used to specify any syntactical and/or semantic aspects of the build. Such executables might be stored in a compiled format (e.g., binary file), each having a unique handle that can be called to invoke a respective executable.

As shown in the entity management technique 200, when a generation event 244 is detected (e.g., due to an administrative action or other precipitating event as described below), executable instances of the entity management functions in the code base are generated and exposed to the generic interface through the data structure (step 236). Such a generation event 244 might occur in response to, for example, a system boot event, a new VE introduction, an entity management function update, and/or other events. In some cases, exposure of the executables to the generic interface can be accomplished by organizing and storing the handles of the executables in the data structure to facilitate a search for the handles by the generic interface.

The shown ongoing operations 240 can commence upon occurrence of a generic interface call event. More specifically, and as shown, the occurrence of a generic interface call event invokes step 242 to receive an entity management call at the generic interface. The call parameters from the received generic interface call are applied to the data structure to map the call to an entity management function (step 246). For example, associations between certain combinations of call parameters and function handles can be captured in the data structure (e.g., each row in a table having a unique combination) so as to identify a particular handle and corresponding entity management function based on a certain set of call parameters. Once an entity management function associated with the received call is identified, the executable for the identified function can be executed in accordance with any access control constraints pertinent to the call (step 248).

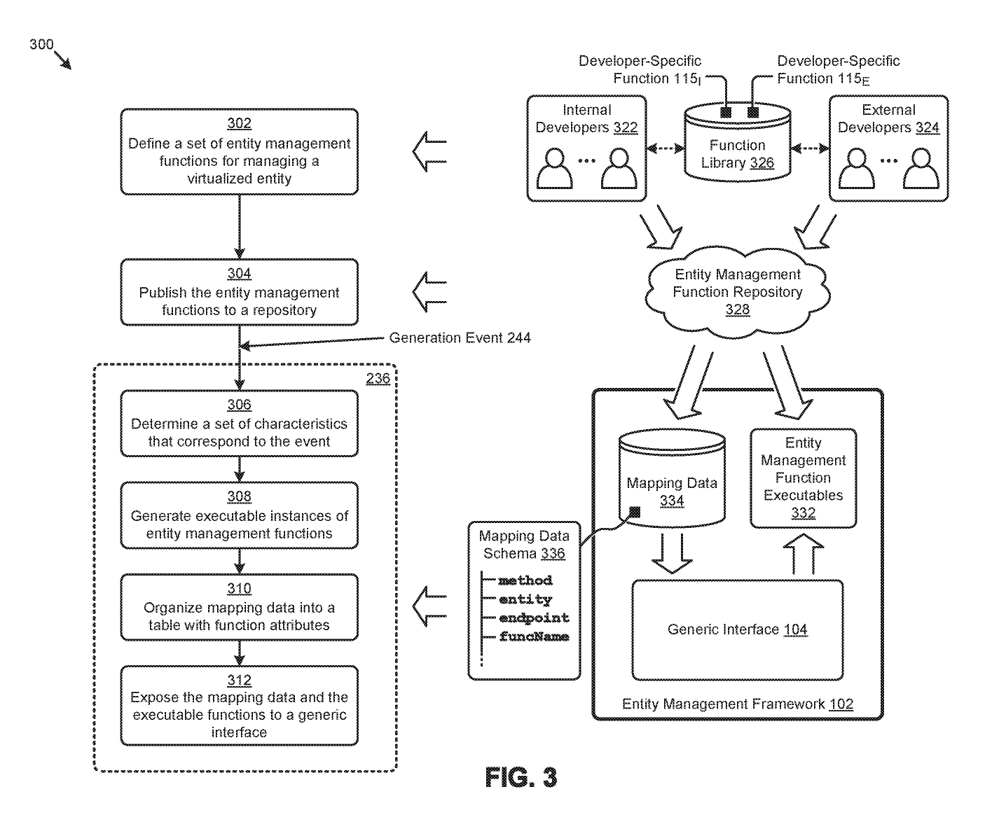

For example, certain calls and associated functions might be authorized for execution when issued by a system administrator, but might not be authorized for execution by a standard user. As shown, user permissions 112 (e.g., “allow” or “deny” indications) can be accessed to facilitate application of such access control constraints when executing the entity management functions. Developer-specific entity data 114 might also be accessed to carry out the entity management functions. Specifically, and as shown, the developer-specific entity data might comprise a code base or pointer to a code base that includes developer-specific function entry points 219, together with an indication of their respective developer ID. Further details associated with the setup operations 230 and ongoing operations 240 are shown and described as pertaining to FIG. 3.

FIG. 3 presents an entity management framework setup technique 300 used in systems that facilitate managing heterogeneous virtualized entities using a generic interface. As an option, one or more variations of entity management framework setup technique 300 or any aspect thereof may be implemented in the context of the architecture and functionality of the embodiments described herein. The entity management framework setup technique 300 or any aspect thereof may be implemented in any environment.

The entity management framework setup technique 300 presents one embodiment of certain steps and/or operations that facilitate setup of a framework (e.g., data structures, executables, interfaces, etc.) for managing heterogeneous virtualized entities using a generic interface. A specialized data structure (e.g., mapping data 334) designed to improve the way a computer stores and retrieves data in memory when performing the entity management framework setup technique 300 and/or other herein disclosed techniques is also shown and described.

Specifically, entity management framework setup technique 300 can commence by defining a set of entity management functions for managing a virtualized entity (step 302). For example, a developer of a VE (e.g., VM, container, containerized application, project, domain, cluster, etc.) might also develop a set of functions that can be used to manage the VE. Specifically, a VM developer might design VM management functions to create, delete, clone, start, stop, pause, or monitor the VM. As shown in FIG. 3, such developers might be internal developers 322 or external developers 324. For example, internal developers 322 might be from within the ownership and/or control of the resources in which the VEs and associated entity management functions are to be deployed, while external developers 324 are external to this environment.

In some cases, the entity management functions defined by the developers comprise a sequence (e.g., pipeline) of operations and/or transformations. These operations can be codified using inline expressions and/or macros and/or lambda functions. Macros are segments of executable code that are referred to by a name that is used in source code. A compiler expands the name into the corresponding segments of executable code. A lambda function is a segment of compliable code that is permitted (e.g., by the compiler) to be defined without requiring a named calling syntax to be defined. In some cases, a lambda function is defined as merely an expression that can be evaluated within any code context. In some cases, a lambda function is defined as a sequence of executable statements that can be executed within any code context.

As earlier indicated in the discussion of FIG. 2, developer-specific entity data 114 might comprise a code base or pointer to a code base that includes developer-specific function entry points 219, together with an indication of their respective developer ID. In another embodiment, and as illustrated, the developers might access a function library 326. A developer or agent operating on behalf of a developer might define their developer-specific and entity management functions and store them in a code base. For example, in this embodiment, function library 326 comprises code from internal developers 322 (e.g., internal developer-specific function 115i) as well as code from external developers (e.g., external developer-specific function 115E).

An entity management function might be defined by a set of lambda functions, each having a corresponding execution order indicator. When an entity management function is defined, it can be published to a code base in a repository, such as in an entity management function repository 328 (step 304).

Upon occurrence of a generation event 244, a series of steps are invoked that serve to generate new callable handles to a web service or microservice, and/or perform update(s) to the code that forms the web service or microservice. As shown, such processing is initiated at step 306, which step detects an entity management function generation event and determines a set of underlying characteristics pertaining to the event. For example, the generation event 244 might have been raised by creation of a new type of virtualized entity, or raised by the occurrence of an entity management function update. Responsive to the event and the determination of a set of underlying characteristics pertaining to the event, executable instances of the entity management functions are generated (step 308). For example, the code base in entity management function repository 328 can be accessed, and content therefrom can be used to populate a set of entity management function executables 332 in the entity management framework 102.

Next, a set of mapping data 334 in entity management framework 102 is populated with various attributes associated with the entity management function executables 332 (step 310). More particularly, the specific attributes that are populated into the mapping data can be derived from any one or more of the underlying characteristics pertaining to the event that were determined in step 306. Strictly as one example, mapping data that forms an entity function map might include a name of an entity, which name is derived from the generation event and/or from other derived characteristics.

The mapping data 334 might be organized and/or stored using various specialized data structures. As one example, mapping data 334 can be organized and/or stored in a mapping data structure comprising a tabular structure (e.g., relational database table). Such a tabular structure might have rows corresponding to a particular executable entity management function instance, and columns corresponding to various attributes pertaining to that instance. Specifically, and as illustrated in the mapping data schema 336, each row of mapping data 334 can comprise, for a given executable entity management function instance, a “method” field describing a call method or request method (e.g., HTTP GET method, HTTP POST method, etc.), an “entity” field describing an entity type, an “endpoint” field describing an entity management function handle (e.g., web service endpoint), a “funcName” field describing an entity management function name, and/or other attributes. The mapping data 334 is populated and the entity management function executables 332 are then exposed to the generic interface 104 in entity management framework 102 (step 312).

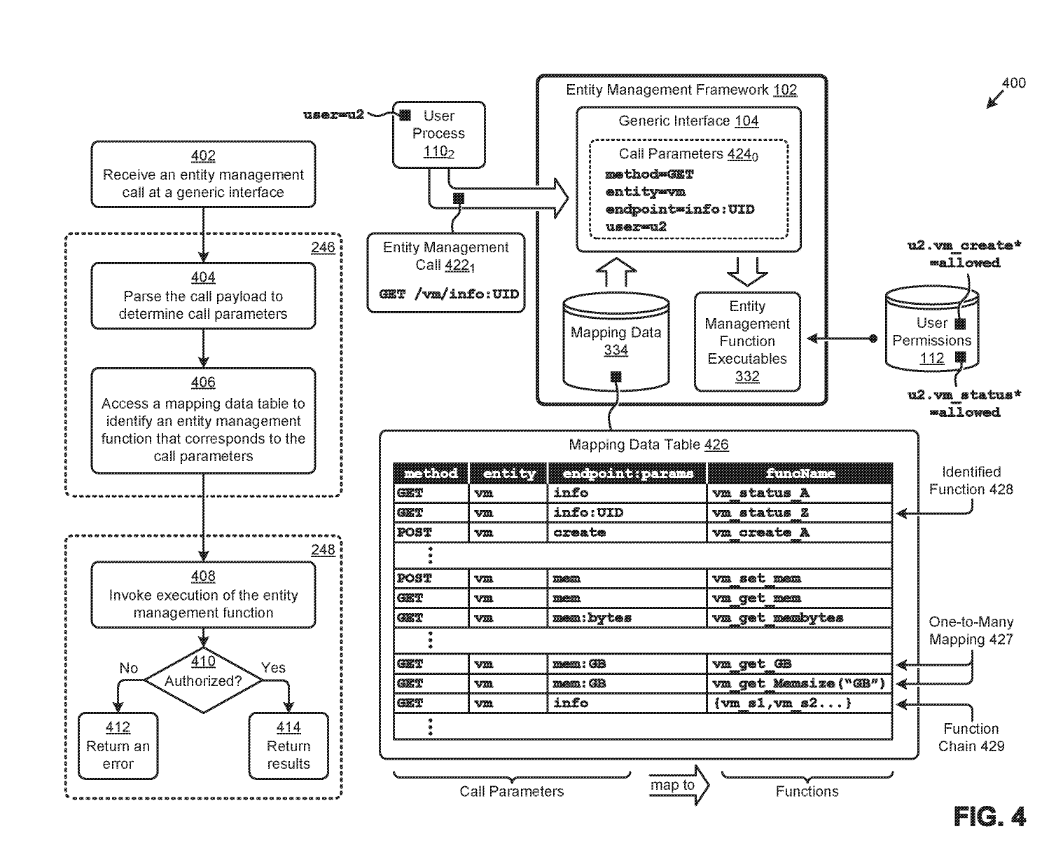

With the entity management framework 102 established, the framework can be used to efficiently manage a dynamic corpus of heterogeneous virtualized entities according to the herein disclosed techniques. One embodiment of such techniques is shown and discussed as pertains to FIG. 4.

FIG. 4 depicts an entity management function execution technique 400 as implemented in systems that facilitate managing heterogeneous virtualized entities using a generic interface. As an option, one or more variations of entity management function execution technique 400 or any aspect thereof may be implemented in the context of the architecture and functionality of the embodiments described herein. The entity management function execution technique 400 or any aspect thereof may be implemented in any environment.

The entity management function execution technique 400 presents one embodiment of certain steps and/or operations that facilitate execution of functions for managing heterogeneous virtualized entities using a generic interface. A specialized data structure (e.g., mapping data 334) is designed to improve the way a computer stores and retrieves data in memory when performing the entity management function execution technique 400. Specifically, entity management function execution technique 400 can commence by receiving an entity management call at a generic interface (step 402). For example, an entity management call 422₁, such as “GET /vm/info:UID” from user process 110₂ having certain user credentials (e.g., “user=u2”), can be issued to generic interface 104 in entity management framework 102. The issued call can be parsed to determine the call parameters (step 404). For example, entity management call 422₁ might be parsed into call parameters 424₀.

The call parameters are then applied to a set of mapping data to identify a corresponding entity management function to be invoked by the call (step 406). More specifically, call parameters 424₀ are applied to mapping data 334 and/or to information in the entity management function executables to identify a developer-specific function to be invoked (step 408). As can be observed, a data structure such as a mapping data table 426 can facilitate the mapping of certain calls and corresponding parameters (e.g., “method”, “entity”, and “endpoint:params”) to a particular function (e.g., identified by a “funcName” handle). For the shown “GET /vm/info:UID” example call, mapping data table 426 indicates the function referred to as “vm_status_Z” is the identified function 428 to be invoked by the call. This is because the UID can be used to look up the developer, which, in this case, is developer ‘Z’. In an alternative, if the generic call were given as “GET /vm/info:UID”, but the UID referred to an entity that corresponds to Developer ‘A’, then the function “vm_status_A” would be mapped-to and then executed.

In many cases, the mapped-to and executed function comprises certain operations pertaining to access control. For example, the credentials of the caller (e.g., “user=u2”) might be used to form a query to access user permissions 112, so as to determine if the caller is authorized to execute the identified function or portions thereof (decision 410). If the caller is authorized (see “Yes” path of decision 410), the results of the executed function are returned (step 414). For example, user permissions 112 might show that user “u2” is allowed to execute any variations of the “vm_create” function (e.g., “u2.vm_create*=allowed”), and also that user “u2” is allowed to execute any variations of the “vm_status” function (e.g., “u2.vm_status*=allowed”). When a particular user is not authorized to execute an identified function (see “No” path of decision 410), an error is returned (step 412).

In some situations, there might be multiple candidates that are to be resolved to a single identified function to be executed. For example, and as shown in mapping data table 426, there might be two or more rows that have the same set of call parameters. In cases where there are two or more candidate rows that map from the same call parameters to two or more different identified functions such as is depicted by the functions “vm_get_GB” and “vm_get_Memsize(“GB”)”, additional processing is carried out to select from the different functions of the candidate rows (as depicted by the one-to-many mapping 427). Such additional processing might include checking for characteristics (e.g., timestamps) of the constituents of the entity management function executables so as to determine a preferred function from among the candidates. Other tests and determinations are possible.

In one specific case of making such determinations, the mapping data table might include syntactical elements that aid in determination of a preferred function to resolve to a single function to be executed when the one-to-many mapping condition is present. For example, and as shown in the depiction of FIG. 4, the “params” of an endpoint specification might include a colon (“:”) and/or “type” operator to delimit portions of an “endpoint:params” specification. In some cases, the syntax given in an “endpoint” field might include information that serves for normalization of parameter values and/or, in some cases, the syntax given in a “parameters” field might include information that serves for making determinations pertaining to normalization and/or for making determinations pertaining to the format of a returned value after execution of the identified function.

As another example, in the depiction of mapping data table of FIG. 4, there are two rows for retrieval of memory size. One of the rows specifies “mem:bytes” (e.g., using the colon operator and an operand referring to bytes) in the “endpoint:params” field, while another row specifies “mem:GB” (e.g., using the colon operator and an operand referring to gigabytes) in the “endpoint:params” field. Any operation of the entity management framework can normalize input and/or output values based on field values that include the colon and/or type operator. Either or neither or both input values and/or output values can be subjected to value normalization.

Moreover, any data type can be subjected to normalization. Strictly as one example, a time value might be normalized to comport with the syntax and semantics of the IETF RFC 3339 specification for Internet time stamping. For many parameters, a default set of syntax and semantics are applied when there is no colon or type operator. Use of the colon or type operator, or explicit specifications in the “endpoint:params” field, overrides any defaults.

In yet other scenarios, mapping data table 426 might include aliases. Aliases are unique identifiers that refer to a corresponding executable function or chain of a series of executable functions. The alias can be implemented as a literal in the “funcName” field so as to refer to a corresponding executable function by the alias literal. In some scenarios, an alias can refer to a chain of a series of executable functions. As an alternative to use of an alias to refer to a chain, one possible permitted syntax of values in the “funcName” field allow for a textual specification of function chain 429. In the example shown, multiple functions are listed in a comma-separated sequence, which sequence is enclosed within braces (e.g., {vm_s1, vm_s2 . . . }). As per the earlier indicated alternative, an alias can be used to refer to the chain rather than recording the chain in the explicit comma-separated sequence.

The mapping data table might include additional columns beyond the columns in the depiction of FIG. 4. Strictly as one example, rather than codify the colon (“:”) operator in the “endpoint” column, that operator and its parameters can be stored in a separate column of the mapping data table. Moreover, the parameters after the colon (“:”) might specify a particular desired type or format of the output. For example, a value in the “endpoint:params” column might be “mem:type=string” to indicate that the return value should be returned as a string. Alternatively, a value in the “endpoint:params” column might be “mem:type=integer” to indicate that the return value should be returned as a number value formatted as an integer. As such, the value or values returned by an executable management function can be post-processed so as to convert the value or values returned by the executable management function into a format as specified by the syntax of the corresponding call.

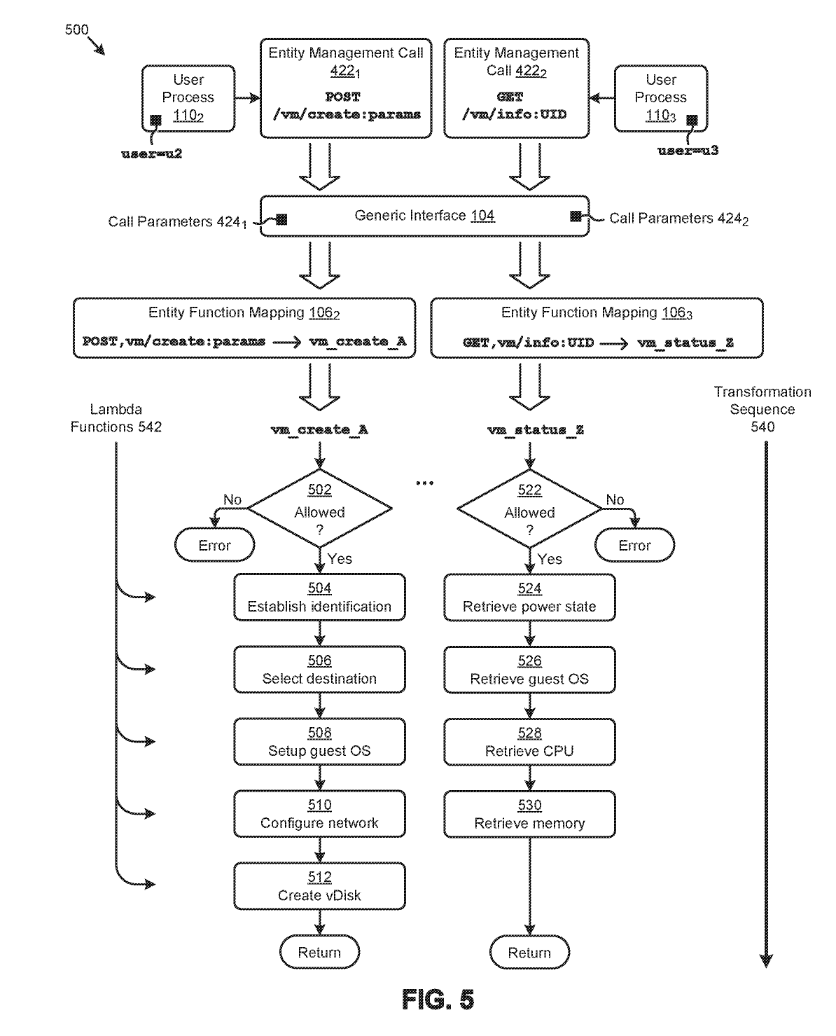

The acts of mapping call parameters through the mapping data table to executable management functions can be carried out using any known techniques for lookup, normalization, aliasing, and resolution to one or more executable management functions. Examples of executable management functions are depicted and discussed as pertaining to FIG. 5.

FIG. 5 depicts diagrammatic representations of entity management functions 500 used by systems that facilitate managing heterogeneous virtualized entities using a generic interface. As an option, one or more variations of entity management functions 500 or any aspect thereof may be implemented in the context of the architecture and functionality of the embodiments described herein. The entity management functions 500 or any aspect thereof may be implemented in any environment.

Many of the aforementioned techniques used to map to developer-specific functions include processing pertaining to characteristics of a particular user, and/or processing pertaining to characteristics of the entity being considered. In many cases, a developer-specific function is delivered as a lambda function that can be called without a known context. For example, a developer-supplied lambda function might be delivered as a macro or expression that can be called from any context, and yet can perform any sort of desired lookup, calculation, and/or transformation. Such a scenario is depicted hereunder. Specifically, FIG. 5 shows how a set of developer-provided lambda functions can be used in an ordered sequence of lookups, calculations, and/or transformations.

The entity management functions vm_create_A and vm_status_Z as shown in FIG. 5 are merely examples of functions that can be called and executed according to the herein disclosed techniques. As shown, entity management call 422₁ indicates a “POST /vm/create:params” call received by generic interface 104. Call parameters 4241 are applied via entity function mapping 1062 to identify the particular executable entity management function, “vm_create_A”. Also, in another scenario, entity management call 4222 indicates a “GET /vm/info:UID”, which includes the specific parameter UID (e.g., a UID for the particular entity of interest) in the call parameters 4242, and which specific UID value is used by the entity function mapping 1063 to identify the particular executable entity management function. In this example, the value of the given UID pertains to an entity developed by developer ‘Z’, therefore the mapping resolves to funcName=“vm_status_Z”.

Information other than only the information provided in the generic interface call can be used to map to a particular executable entity management function. As an example, an entity management call 422₁ (e.g., “POST /vm/create:params”) from user process 110₂ having certain user credentials (e.g., “user=u2”), and a UID of an entity by developer ‘A’ is issued to generic interface 104. The call parameters in this case are used in conjunction with the user credentials and the UID, and the generic call is thusly mapped to the “vm_create_A” function as shown in entity function mapping 1062. Moreover, and as depicted in FIG. 5, the “vm_create_A” function commences only after checking if the caller (e.g., user process 110₂) has sufficient permissions to execute the “vm_create_A” function (decision 502). In some cases, permissions can be determined by a role. For example, a system administrator might be granted “admin” credentials. If the caller does not have sufficient permissions (see “No” path of decision 502), an error is returned. However, if the caller does have sufficient permissions, then the user is allowed to execute the “vm_create_A” function (see “Yes” path of decision 502).

The granted permissions might derive from one or many sources, possibly including any aspect of an individual user, or user group, or tenant, or tenant group, or enterprise, or resource owner, etc. Permissions might be provided in a centralized location such as the shown dataset of user permissions 112 of FIG. 4, or permissions might be distributed in various forms throughout the computing system. Given sufficient permissions, the VM creation process commences by establishing identification attributes for the VM (step 504). The shown function continues with selection of a VM deployment destination (step 506), setup of a VM guest operating system or OS (step 508), configuration of VM networking facilities (step 510), and creation of a virtual disk or vDisk to be attached to the VM (step 512). Results indicating a successful execution of the “vm_create_A” function are then returned to the caller.

As another example, an entity management call 4222 (e.g., “GET /vm/info:UID”) from user process 1103 having certain user credentials (e.g., “user=u3”) is issued to generic interface 104. The call parameters in this case are mapped to the “vm_status_Z” function as shown in the entity function mapping 1063. As depicted in FIG. 5, the “vm_status_Z” function commences by checking if the caller (e.g., user process 1103) has sufficient permissions (decision 522). If the caller does not have sufficient permissions (see “No” path of decision 522), an error is returned. However, if the caller does have sufficient permissions, then the user is allowed to execute the “vm_status_Z” function (see “Yes” path of decision 522). The VM status retrieval process commences by retrieving the power state of a VM (step 524). The function can continue with retrieval of the VM guest OS type (step 526), retrieval of a CPU type (step 528), and retrieval of memory allocations (step 530). As one example of a retrieval process, a retrieval could be performed by making calls to one or more further lambda functions, or through an access or query to a table or database. Results (e.g., a data structure and/or a status indication) of the execution are then returned to the caller.

As depicted in FIG. 5, any of the executable entity management functions can be described as a sequence (e.g., pipeline) of transformations that comprise a transformation sequence 540 or “transformer”. As further shown, transformation sequence 540 of an entity management function can comprise, for example, a set of macros or expressions, such as lambda functions 542. As a specific example, lambda function pseudo code for the “vm_status_Z” function of FIG. 5 is shown in Table 1.

TABLE 1
Example lambda function pseudo code for
“vm_status_z” function

| Operation/Step | Lambda function |
|---|---|
| Decision 522 | auth : (x,y) => return x.permissions==y |
| Step 524 | pwr : x => return x.pwr_state |
| Step 526 | gOS : x => return x.guestOS |
| Step 528 | cpu : x => return x.cpu |
| Step 530 | mem : x => return x.memory |

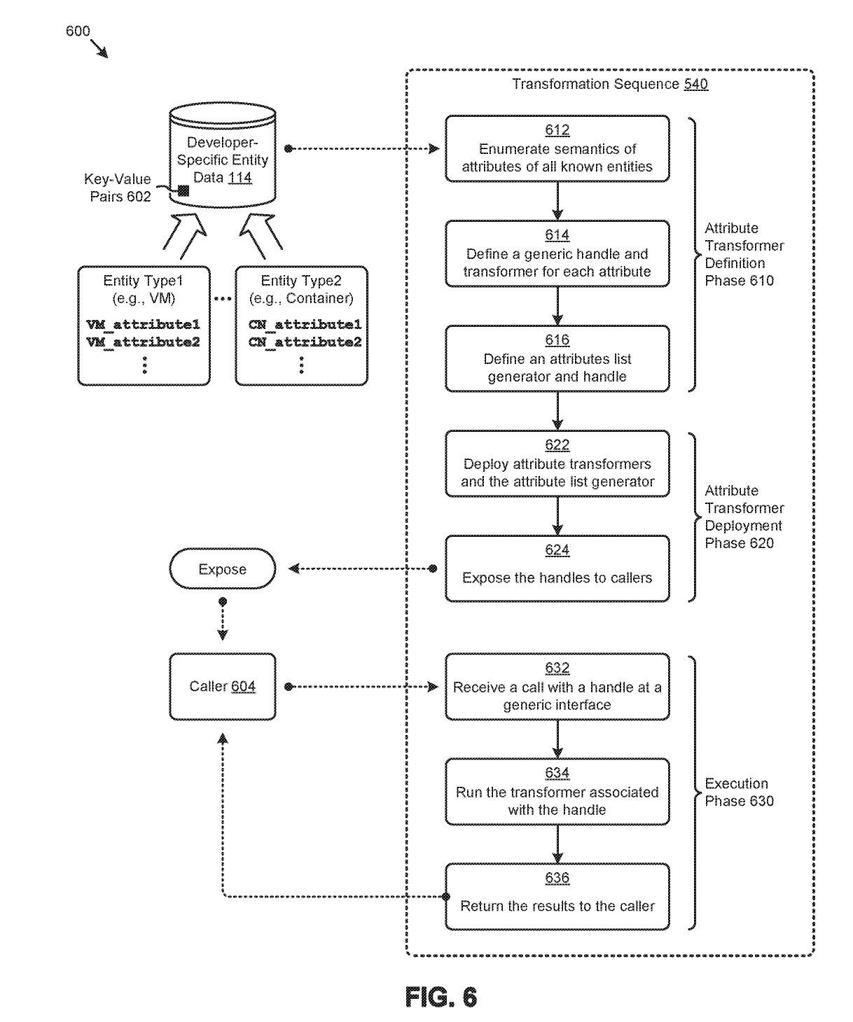

An embodiment of an entity attribute transformer technique that implements transformation sequences is shown and described as pertains to FIG. 6.

FIG. 6 presents an attribute transformer implementation technique 600 that facilitates managing heterogeneous virtualized entities using a generic interface. As an option, one or more variations of attribute transformer implementation technique 600 or any aspect thereof may be implemented in the context of the architecture and functionality of the embodiments described herein. The attribute transformer implementation technique 600 or any aspect thereof may be implemented in any environment.

The attribute transformer implementation technique 600 presents one embodiment of certain steps and/or operations that can be grouped according to an attribute transformer definition phase 610, an attribute transformer deployment phase 620, and an execution phase 630. Specifically, in attribute transformer definition phase 610, the attribute transformer implementation technique 600 examines key-value pairs 602 from developer-specific entity data 114 to enumerate semantics of the attributes (and their representation as key-value pairs 602) for all known entities (e.g., entity type1, entity type2, etc.) (step 612). A generic handle (e.g., semantically meaningful handle) and associated transformer (e.g., sequence or pipeline of transforms) is defined for each attribute (e.g., via respective one or more key-value pairs) (step 614). For example, the transformer can be a function to set or retrieve the value or values pertaining to a particular attribute. When the semantics of two or more attributes (e.g., key-value pairs) are the same, a common handle (e.g., API) to call the associated transformer can be defined. In some cases, an attributes list generator and associated handle are also defined (step 616).

In the attribute transformer deployment phase 620, the attribute transformers and the list generator are deployed (step 622). The handles (e.g., API call interface) are also exposed to the callers (step 624). In some cases, an agent (e.g., an attribute transformer agent) to process handle calls is deployed in the computing environment. As an example, the agent can be a generic interface.

The execution phase 630 can commence with a caller 604 issuing a call to one of the exposed handles, which is received at a generic interface (e.g., attribute transformer agent) (step 632). The call is processed to run the transformer associated with the handle (step 634) and return the results to the caller (step 636). For example, calling the attributes list generator might return a list of handles for performing certain operations over various attributes, after which the caller can make additional calls using the returned list of handles.

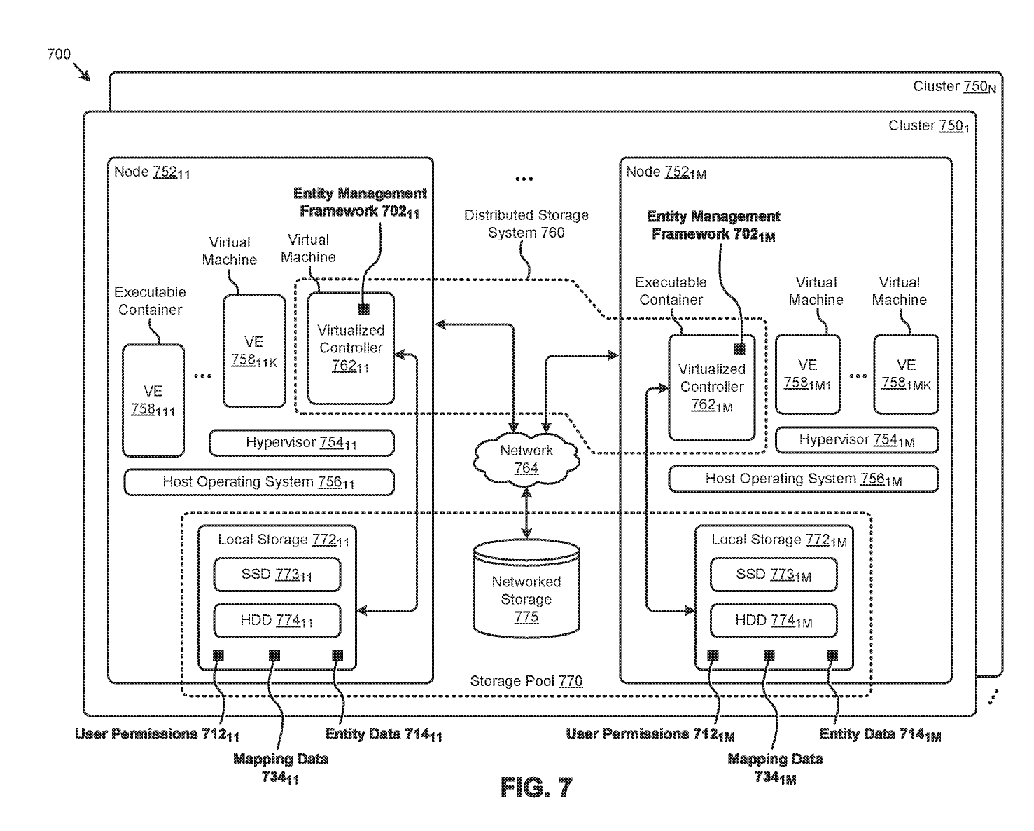

An example of a distributed virtualization environment that supports any of the herein disclosed techniques is presented and discussed as pertains to FIG. 7.

FIG. 7 depicts a distributed virtualization environment 700 in which embodiments of the present disclosure can be implemented. As an option, one or more variations of distributed virtualization environment 700 or any aspect thereof may be implemented in the context of the architecture and functionality of the embodiments described herein.

The shown distributed virtualization environment depicts various components associated with one instance of a distributed virtualization system (e.g., hyperconverged distributed system) comprising a distributed storage system 760 that can be used to implement the herein disclosed techniques. Specifically, the distributed virtualization environment 700 comprises multiple clusters (e.g., cluster 750₁, . . . , cluster 750_{N}) comprising multiple nodes that have multiple tiers of storage in a storage pool. Representative nodes (e.g., node 752₁₁, . . . , node 752_{1M}) and storage pool 770 associated with cluster 750₁ are shown. Each node can be associated with one server, multiple servers, or portions of a server. The nodes can be associated (e.g., logically and/or physically) with the clusters. As shown, the multiple tiers of storage include storage that is accessible through a network 764, such as a networked storage 775 (e.g., a storage area network or SAN, network attached storage or NAS, etc.). The multiple tiers of storage further include instances of local storage (e.g., local storage 772₁₁, . . . , local storage 7721M). For example, the local storage can be within or directly attached to a server and/or appliance associated with the nodes. Such local storage can include solid state drives (SSD 773 . . . , SSD 773_{1M}), hard disk drives (HDD 774₁₁, HDD 774_{1M}), and/or other storage devices.

As shown, the nodes in distributed virtualization environment 700 can implement one or more user virtualized entities (e.g., VE 7581₁₁, VE 7581_{1K}, VE 758_{1M1}, . . . , VE 758_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 756₁₁, . . . , host operating system 756_{1M}), while the VMs run multiple applications on various respective guest operating systems. Such flexibility can be facilitated at least in part by a hypervisor (e.g., hypervisor 754₁₁, . . . , hypervisor 754_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 756₁₁, . . . , host operating system 756_{1M}) without, in most cases, a hypervisor layer. This lightweight implementation can facilitate efficient distribution of certain software components, such as applications or services (e.g., micro-services). As shown, distributed virtualization environment 700 can implement both a hypervisor-assisted virtualization environment and a container virtualization environment for various purposes.

Distributed virtualization environment 700 also comprises at least one instance of a virtualized controller to facilitate access to storage pool 770 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a layer in a hypervisor).

Multiple instances of such virtualized controllers can coordinate within a cluster to form the distributed storage system 760 which can, among other operations, manage the storage pool 770. This architecture further facilitates efficient scaling of the distributed virtualization system. The foregoing virtualized controllers can be implemented in distributed virtualization environment 700 using various techniques. Specifically, an instance of a virtual machine at a given node can be used as a virtualized controller in a hypervisor-assisted virtualization environment to manage storage and I/O (input/output or JO) activities. In this case, for example, the virtualized entities at node 752₁₁ can interface with a controller virtual machine (e.g., virtualized controller 762₁₁) through hypervisor 754₁₁ to access the storage pool 770. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 760.

For example, a hypervisor at one node in the distributed storage system 760 might correspond to VMware ESXi software, and a hypervisor at another node in the distributed storage system 760 might correspond to Nutanix AHV software. As another virtualized controller implementation example, containers (e.g., Docker containers) can be used to implement a virtualized controller (e.g., virtualized controller 762_{1M}) in an operating system virtualization environment at a given node. In this case, for example, the virtualized entities at node 752_{1M} can access the storage pool 770 by interfacing with a controller container (e.g., virtualized controller 762_{1M}) through hypervisor 754_{1M} and/or the kernel of host operating system 756_{1M}.

In certain embodiments, one or more instances of an entity management framework can be implemented in the distributed storage system 760 to facilitate the herein disclosed techniques. Specifically, entity management framework 702₁₁ can be implemented in the virtualized controller 762₁₁, and entity management framework 702_{1M} can be implemented in the virtualized controller 762_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents (e.g., a reverse proxy authorization service). Also, one or more instances of mapping data, user permissions data, and/or entity data can be implemented in local storage or in networked storage or both, in any location and/or in any combination within the storage pool 770. As shown, mapping data 734₁₁, user permissions 712₁₁, and entity data 714₁₁ are stored in local storage 772₁₁. Also, mapping data 734_{1M}, user permissions 712_{1M}, and entity data 714_{1M} are stored in local storage 7721M.

### Additional Embodiments of the Disclosure

### Additional Practical Application Examples

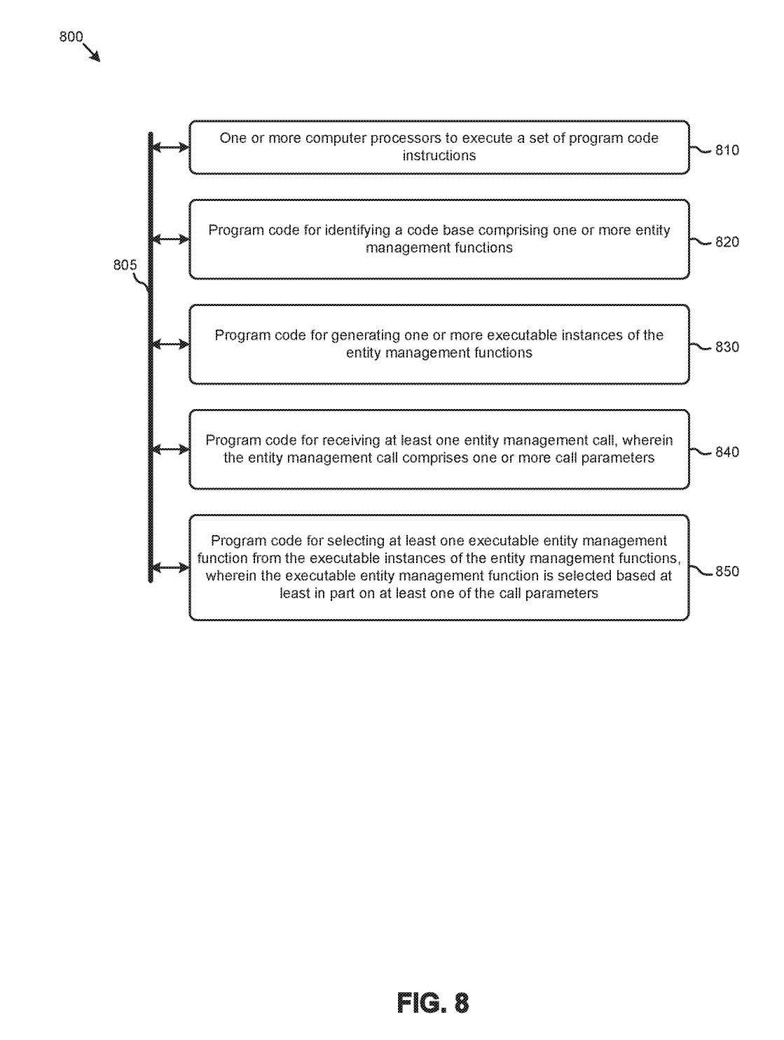

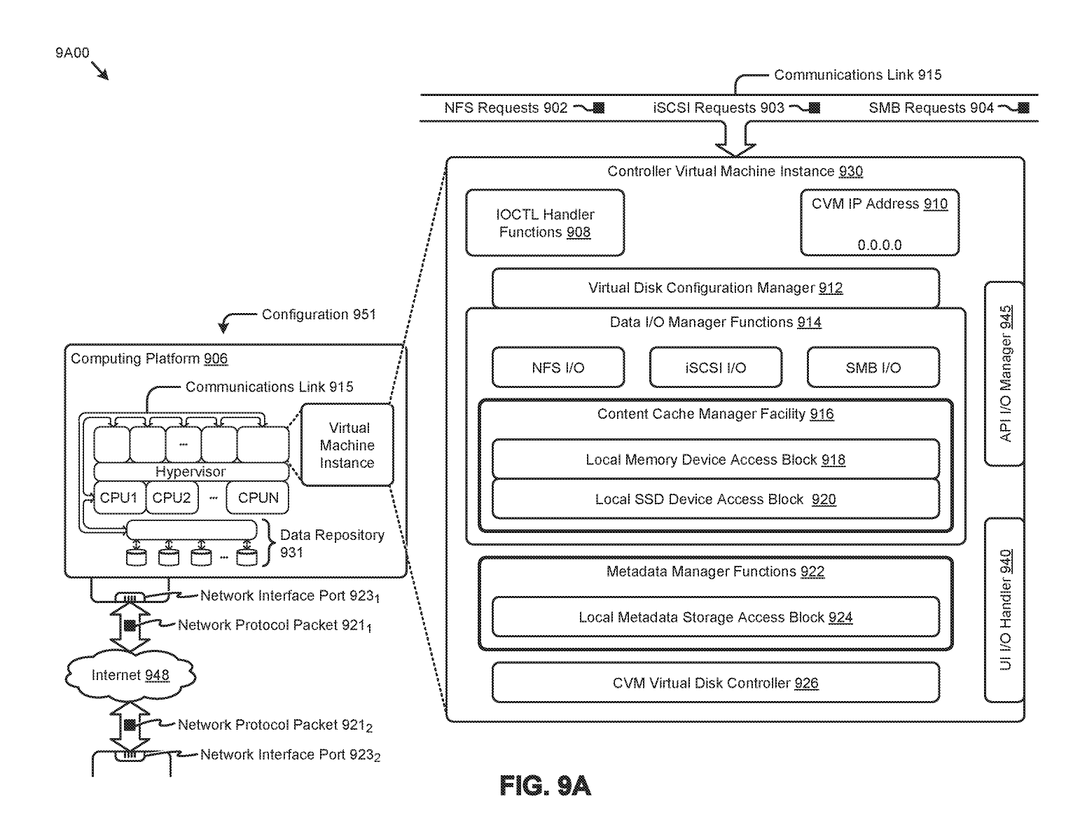

FIG. 8 depicts a system 800 as an arrangement of computing modules that are interconnected so as to operate cooperatively to implement certain of the herein-disclosed embodiments. This and other embodiments present particular arrangements of elements that, individually and/or as combined, serve to form improved technological processes that address problems attendant to efficiently managing a dynamically-changing corpus of heterogeneous virtualized entities. The partitioning of system 800 is merely illustrative and other partitions are possible. As an option, the system 800 may be implemented in the context of the architecture and functionality of the embodiments described herein. Of course, however, the system 800 or any operation therein may be carried out in any desired environment.

The system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims.

The shown embodiment implements a portion of a computer system, presented as system 800, comprising one or more computer processors to execute a set of program code instructions (module 810) and modules for accessing memory to hold program code instructions to perform: identifying a code base comprising one or more entity management functions (module 820); generating one or more executable instances of the entity management functions (module 830); receiving at least one entity management call, wherein the entity management call comprises one or more call parameters (module 840); and selecting at least one executable entity management function from the executable instances of the entity management functions, wherein the executable entity management function is selected based at least in part on at least one of the call parameters (module 850).

Variations of the foregoing may include more or fewer of the shown modules. Certain variations may perform more or fewer (or different) steps, and/or certain variations may use data elements in more, or in fewer (or different) operations. Still further, some embodiments include variations in the operations performed, and some embodiments include variations of aspects of the data elements used in the operations.

### System Architecture Overview

### Additional System Architecture Examples

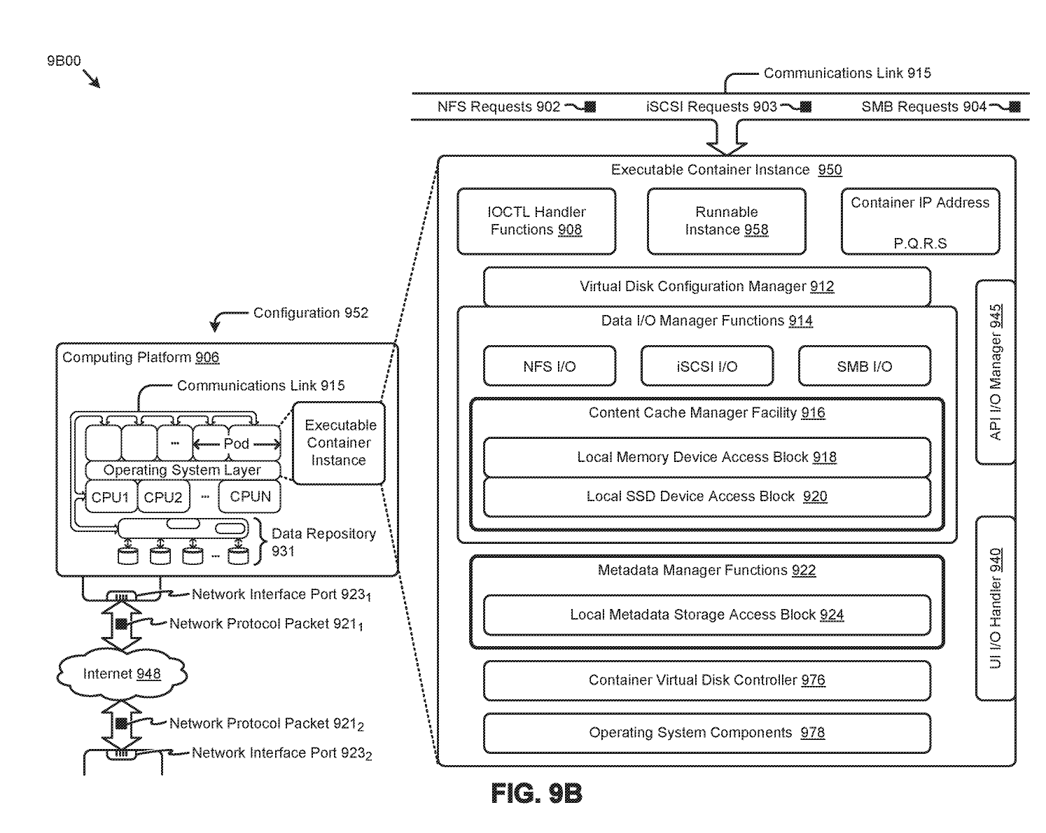

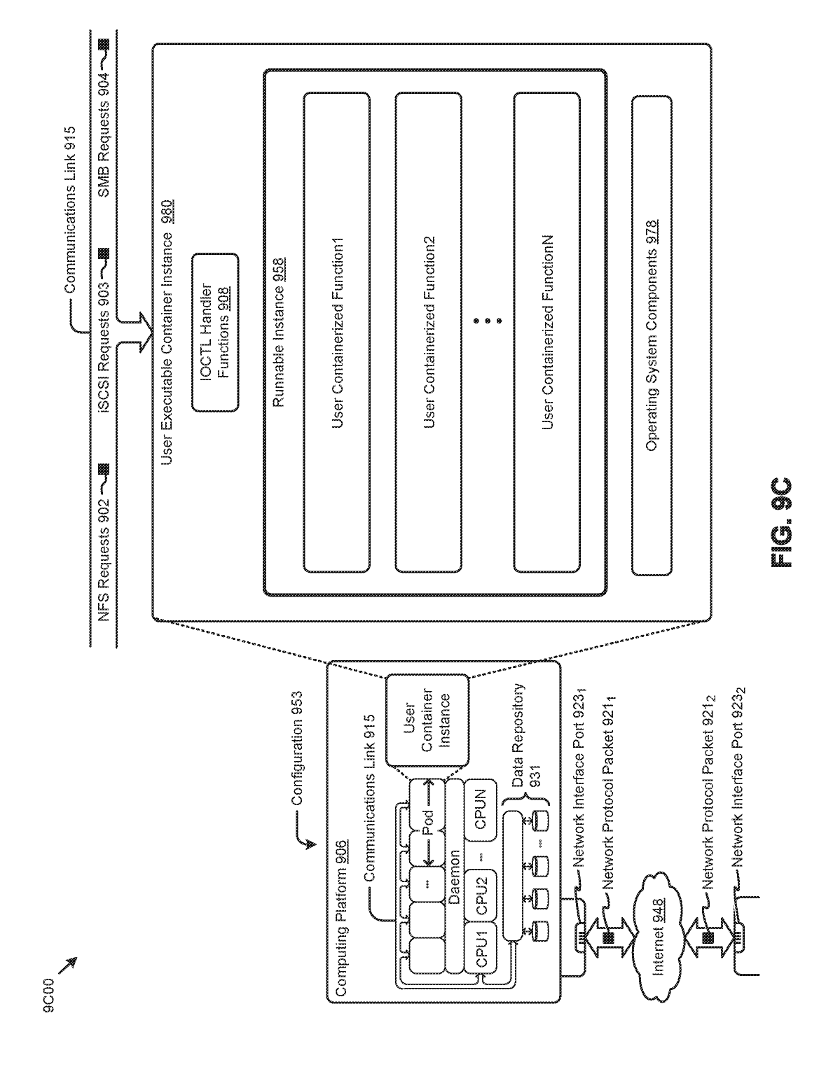

FIG. 9A depicts a virtualized controller as implemented by the shown virtual machine architecture 9A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high-performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, the virtual machine architecture 9A00 comprises a collection of interconnected components suitable for implementing embodiments of the present disclosure and/or for use in the herein-described environments. Moreover, the shown virtual machine architecture 9A00 includes a virtual machine instance in configuration 951 that is further described as pertaining to controller virtual machine instance 930. Configuration 951 supports virtual machine instances that are deployed as user virtual machines, or controller virtual machines or both. Such virtual machines interface with a hypervisor (as shown). Some virtual machines include processing of storage I/O as received from any or every source within the computing platform. An example implementation of such a virtual machine that processes storage I/O is depicted as 930.

In this and other configurations, a controller virtual machine instance receives block I/O (input/output or IO) storage requests as network file system (NFS) requests in the form of NFS requests 902, and/or internet small computer storage interface (iSCSI) block IO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output (I/O or IO) can be handled by one or more IO control handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS TO, iSCSI TO, SMB TO, etc.).

In addition to block IO functions, configuration 951 supports IO of any form (e.g., block TO, streaming TO, packet-based TO, HTTP traffic, etc.) through either or both of a user interface (UI) handler such as UI IO handler 940 and/or through any of a range of application programming interfaces (APIs), possibly through the shown API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 930 includes content cache manager facility 916 that accesses storage locations, possibly including local dynamic random access memory (DRAM) (e.g., through the local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 931, which in turn can be formatted into any one or more storage areas, and which can comprise parameterized storage accessible by a key (e.g., a filename, a table name, a block address, an offset address, etc.). External data repository 931 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 924. External data repository 931 can be configured using CVM virtual disk controller 926, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 951 can be coupled by communications link 915 (e.g., backplane, LAN, PSTN, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 923₁ and network interface port 923₂). Configuration 951 can be addressed through one or more network interface ports using an IP address. Any operational element within computing platform 906 can perform sending and receiving operations using any of a range of network protocols, possibly including network protocols that send and receive packets (e.g., network protocol packet 921₁ and network protocol packet 921₂).

Computing platform 906 may transmit and receive messages that can be composed of configuration data and/or any other forms of data and/or instructions organized into a data structure (e.g., communications packets). In some cases, the data structure includes program code instructions (e.g., application code) communicated through the Internet 948 and/or through any one or more instances of communications link 915. Received program code may be processed and/or executed by a CPU as it is received and/or program code may be stored in any volatile or non-volatile storage for later execution. Program code can be transmitted via an upload (e.g., an upload from an access device over the Internet 948 to computing platform 906). Further, program code and/or the results of executing program code can be delivered to a particular user via a download (e.g., a download from computing platform 906 over the Internet 948 to an access device).

Configuration 951 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to the other units. In some cases, a unit in a rack is dedicated to environmental conditioning functions such as filtering and movement of air through the rack and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to implement algorithms that facilitate operational and/or performance characteristics pertaining to managing heterogeneous virtualized entities using a generic interface. In some embodiments, a module may include one or more state machines and/or combinational logic used to implement or facilitate the operational and/or performance characteristics pertaining to managing heterogeneous virtualized entities using a generic interface.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of techniques for managing heterogeneous virtualized entities using a generic interface). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to managing heterogeneous virtualized entities using a generic interface, and/or for improving the way data is manipulated when performing computerized operations pertaining to mapping generically-structured entity management calls to entity-specific management functions that are executed in accordance with access control constraints.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance in configuration 952 that is further described as pertaining to the executable container instance 950. Configuration 952 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls-a”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular operating system so as to perform its range of functions.

In some environments multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown daemon-assisted containerized architecture 9C00 includes a user executable container instance in configuration 953 that is further described as pertaining to user executable container instance 980. Configuration 953 includes a daemon layer (as shown) that performs certain functions of an operating system.

User executable container instance 980 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this daemon-assisted containerized architecture, computing platform 906 might or might not host operating system components other than operating system components 978. More specifically, the shown daemon might or might not host operating system components other than operating system components 978 of user executable container instance 980.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for providing generic access web service entry points for respective virtualized entities in a computing system, the method comprising:
identifying a code base comprising one or more entity management functions;
generating a map between one or more of the web service entry points to executable instances of the one or more entity management functions;
receiving at least one entity management call, wherein the entity management call comprises one or more call parameters; and
selecting at least one executable entity management function from the executable instances of the entity management functions, wherein the executable entity management function is selected based at least in part on at least one of the call parameters.

2. The method of claim 1, wherein at least one of the entity management functions comprises one or more access control constraints.

3. The method of claim 1, further comprising executing the executable entity management function.

4. The method of claim 3, wherein results of the executable entity management function are formatted in accordance with a type operator.

5. The method of claim 1, wherein selecting the executable entity management function comprises:
applying the at least one of the call parameters to the map; and
identifying the executable entity management function by an association between the at least one of the call parameters and the executable entity management function in the map.

6. The method of claim 5, wherein the map is organized in a mapping data structure that associates at least two of, a request method, an entity type, an entity management function handle, a web service endpoint, or an entity management function name.

7. The method of claim 1, wherein the entity management call is structured to be received at a generic interface.

8. The method of claim 1, wherein at least one of the entity management functions is developed by at least one of, one or more internal developers, or one or more external developers.

9. The method of claim 1, wherein at least one of the entity management functions comprises at least one of, one or more macros or expressions, or one or more lambda functions.

10. A computer readable medium, embodied in a non-transitory computer readable medium, the non-transitory computer readable medium having stored thereon a sequence of instructions which, when stored in memory and executed by one or more processors causes the one or more processors to perform a set of acts for providing generic access web service entry points for respective virtualized entities in a computing system, the acts comprising:
identifying a code base comprising one or more entity management functions;
generating a map between one or more of the web service entry points to executable instances of the one or more entity management functions;
receiving at least one entity management call, wherein the entity management call comprises one or more call parameters; and
selecting at least one executable entity management function from the executable instances of the entity management functions, wherein the executable entity management function is selected based at least in part on at least one of the call parameters.

11. The computer readable medium of claim 10, wherein at least one of the entity management functions comprises one or more access control constraints.

12. The computer readable medium of claim 10, further comprising instructions which, when stored in memory and executed by the one or more processors causes the one or more processors to perform acts of executing the executable entity management function.

13. The computer readable medium of claim 12, wherein results of the executable entity management function are formatted in accordance with a type operator.

14. The computer readable medium of claim 10, wherein selecting the executable entity management function comprises:
applying the at least one of the call parameters to the map; and
identifying the executable entity management function by an association between the at least one of the call parameters and the executable entity management function in the map.

15. The computer readable medium of claim 14, wherein the map is organized in a mapping data structure that associates at least two of, a request method, an entity type, an entity management function handle, a web service endpoint, or an entity management function name.

16. The computer readable medium of claim 10, wherein the entity management call is structured to be received at a generic interface.

17. The computer readable medium of claim 10, wherein at least one of the entity management functions is developed by at least one of, one or more internal developers, or one or more external developers.

18. The computer readable medium of claim 10, wherein at least one of the entity management functions comprises at least one of, one or more macros or expressions, or one or more lambda functions.

19. A system for providing generic access web service entry points for respective virtualized entities in a computing system, the system comprising:
a storage medium having stored thereon a sequence of instructions; and
one or more processors that execute the instructions to cause the one or more processors to perform a set of acts, the acts comprising,
identifying a code base comprising one or more entity management functions;
generating a map between one or more of the web service entry points to executable instances of the one or more entity management functions;
receiving at least one entity management call, wherein the entity management call comprises one or more call parameters; and
selecting at least one executable entity management function from the executable instances of the entity management functions, wherein the executable entity management function is selected based at least in part on at least one of the call parameters.

20. The system of claim 19, wherein at least one of the entity management functions comprises one or more access control constraints.
